(19) United States
(12) Patent Application Publication
(10) Pub. No.: US 2014/0072250 A1
(43) Pub. Date: Mar. 13, 2014

(54) BEARING ASSEMBLY, FAN, AND METHOD FOR GUIDING A SHAFT

(71) Applicant: Aktiebolaget SKF, Goteborg (SE)

(72) Inventors: Henning Kern, Schweinfurt (DE); Jochen Lorenscheit, Rimpar (DE); Horst Niedermeyer, Kolitzheim (DE); Ilim Topaloglu, Schweinfurt (DE)

(73) Assignee: Aktiebolaget SKF, Goteborg (SE)

(21) Appl. No.: 14/025,311

(22) Filed: Sep. 12, 2013

(30) Foreign Application Priority Data
Sep. 12, 2012 (DE) 102012216209.7

(51) Int. Cl. F16C 32/06; F16C 33/72

(52) U.S. Cl. CPC F16C 32/0637; F16C 33/72
USPC 384/119; 384/114

(57) ABSTRACT

A bearing assembly includes a bearing formed to at least radially guide a shaft, a seat for the bearing, an annular gap around the bearing between the bearing and the seat that allows the bearing to undergo a movement perpendicular to an axis of the bearing, a magnetorheological fluid in the gap and a magnetic field source configured to subject the magnetorheological fluid to a magnetic field. Also, a method of controlling a strength of the magnetic field generated by the magnetic field source to control a viscosity of the magnetorheological fluid and affect an operating condition of the bearing assembly.

### CROSS-REFERENCE

This application claims priority to German patent application no 2012 216 209.7 filed on Sep. 12, 2012, the contents of which are fully incorporated herein by reference.

### TECHNICAL FIELD

Exemplary embodiments relate to a bearing assembly, a method for guiding a shaft, and a non-transient computer readable medium storing instructions for causing a computer carry out such a method.

### BACKGROUND

In many fields of machine-, factory-, and vehicle engineering, shafts are used that rotate (or that can rotate) with respect to another component. Unbalanced forces acting on a shaft and/or parasitic influences that occur during rotation of the shaft about its axis of rotation may cause the shaft to experience undesirable forces and torques. Such forces and torques can lead to a movement of the shaft in a direction perpendicular to the axis of rotation of the bearing. In a state of equilibrium, the rotational axis of the shaft generally matches an axis of a bearing used for supporting the shaft, but may be driven from this equilibrium by outside forces.

Overhung high-speed fans are an example of components having rotating shafts that may be adversely affected by unbalanced forces. When such fans are operated there is a risk that the operating rotational speed will be near or at a resonant speed or within a range of resonant speeds of the fan, and this may cause movement of the shaft in a direction perpendicular to its axis of rotation which in turn can lead to significant vibration problems.

The critical rotational speed of a shaft or overhung fan can be increased in a conventional manner by increasing the stiffness of the shaft to help ensure a sufficiently large difference between the critical speed and an operating speed of the shaft or fan. In a conventional bearing assembly, a high overall stiffness may be achieved with large shaft cross-sections and large bearings; however, the provision of such features may adversely affect other aspects of fan operation.

DE 38 42 230 C1 describes a fan including an overhung impeller, in which a shaft is supported by two rolling-element bearings spaced apart from each other in a bearing block or bearing seat. The impeller-side rolling-element bearing is supported externally in a bushing which is disposed in the bearing block with radial clearance/play, and the gap formed by the clearance is sealed on its axial end and provided with an external oil supply that can keep the gap filled with oil during operation. A spring assembly is also provided which biases or urges the bushing. In this manner, the bushing can be centered against the static bearing load by the spring assembly. The coupling or clutch-side bearing, on the other hand, is designed as a fixed bearing that uses a ball bearing in a conventionally manner

Such an assembly can be operated at rotational speeds both above and below a critical rotational speed, and the dynamic amplitude peaks that occur at the resonance point in question are damped by the oil-filled gap. However, the resonance range of this type of device, the range over which resonance effects can occur, may be large. Crossing this resonance range to operating points above and below the range may adversely affect the fan and its shaft and negatively influence the reliability of the fan.

Similar challenges also arise in factory-, machine-, and vehicle engineering. There is therefore a need to provide a bearing assembly and a corresponding method which increases the reliability of a corresponding factory, machine, or subassembly.

### SUMMARY

A bearing assembly according to an exemplary embodiment can be used to support a fan shaft. The bearing assembly includes a bearing that is formed to at least radially guide a shaft and a seat for the bearing formed such that an annular gap surrounding the bearing is formed between the bearing and the seat. This construction allows the bearing to move perpendicular to an axis of the bearing. The gap contains a magnetorheological fluid, and a magnetic field source which is provided for subjecting the magnetorheological fluid to a magnetic field.

Such bearings often include first and second bearing rings that are rotatable with respect to each other, and the axis of the bearing can represent the axis of rotation of the particular relative movement of the two bearing rings relative to each other. In this case, the bearing can be a rolling-element bearing or a sliding bearing.

The present inventors have recognized that a bearing according to the present invention may be more reliable than conventional bearings and that such bearings may improve the operational reliability of factories, machines, or subassemblies in which such a bearing is used. This improvement is obtained, at least in part by an intentional manipulation of the viscosity of a magnetorheological fluid in the gap of the bearing assembly. In this manner, the resonance behavior of the bearing assembly with respect to movement perpendicular to the axis of the bearing can be influenced.

In a bearing assembly according to an exemplary embodiment, at least one seal element can also optionally be provided, comprising, for example, at least one O-ring, and the at least one seal element is formed to seal the gap and exert a spring effect on the bearing perpendicular to the axis of the bearing. In addition, the at least one seal element can optionally be precisely designed such that it exclusively provides the appropriate spring effect. By using the seal element, both a sealing of the gap along the axis of the bearing and the above-described spring effect perpendicular to the axis of the bearing are provided. In this way an additional spring element can thus optionally be omitted due to the provision of the seal element. In this way the operational reliability can also thereby be increased by optionally omitting components using simpler means of construction, since the arrangement has fewer parts in which defects may occur.

In a bearing assembly according to an exemplary embodiment, the bearing assembly can optionally be designed such that at a nominal rotation speed the bearing assembly is operative in a supercritical operating state. In other words, the nominal rotational speed of the bearing assembly can be above a critical rotational speed that represents the resonant frequency of the bearing assembly. Depending on the specific configuration, the corresponding design can be realized based exclusively on the above-described spring effect of the at least one seal element.

In a bearing assembly according to an exemplary embodiment, the magnetic field source can optionally be formed to subject the magnetorheological fluid to a magnetic field having an adjustable or controllable strength. By controlling or changing the magnetic field it is thus possible to influence or change the viscosity of the magnetorheological fluid in the gap thus making the natural frequency of the bearing assembly variable. In a bearing assembly according to an exemplary embodiment, the magnetic field source can optionally thus comprise a coil, a conductor loop, or another conductor, using which the magnetic field is correspondingly adjustable.

Such a bearing assembly can optionally further comprise a control apparatus which is formed to control the magnetic field such that when a critical speed of the bearing assembly is approached, the magnetorheological fluid is subjected to a magnetic field of such a strength that an operating state of the bearing assembly changes from an supercritical to a subcritical operating state, or from a subcritical to a supercritical operating state. In this way it can be possible to define a period of time during which the bearing is in the range of the critical operating state, thus for example in the range of a critical rotational speed band, by using the control apparatus to bring the bearing assembly from a supercritical to a subcritical operational state, or vice versa, by controlling the strength of the magnetic field in a targeted manner. In this way the operational reliability of a bearing assembly according to an exemplary embodiment can be improved such that the change between the respective operating states over the critical range can be accelerated (the time spent operating in the critical range can be reduced) by controlling the magnetic field source.

Such a bearing assembly according to an exemplary embodiment can also optionally be formed such that only the change in the operating state is achievable by changing the strength of the magnetic field. In other words, the bearing assembly, the magnetic field source, and/or the bearing can optionally be designed such that without a change in the rotational speed of the shaft, the change of the operating states over the critical operating state is achievable.

A bearing assembly according to an exemplary embodiment can optionally further comprise at least one sensor for at least partially capturing a momentary operating state of the bearing assembly, which sensor is coupled to the control apparatus. The control apparatus is formed to at least partially control the magnetic field based on the current operating state detected, sensed or captured by the sensor in order to change the operating state of the bearing assembly. In this way it can optionally be possible to consider a more precise reaction to the behavior of the bearing assembly when changing the operating states and thus in turn to improve the operational reliability of the bearing assembly.

In a bearing assembly according to an exemplary embodiment, the control apparatus can optionally be formed to control the magnetic field based on a closed control loop in order to effect the change of the operating state. Such a regulation/control can for example comprise sensing or detecting an amplitude or other vibration-related information with respect to a movement of the shaft or of the associated bearing perpendicular to the axis of the bearing. Alternatively, the control apparatus can be formed so as to control the magnetic field based on a triggering or the crossing of a threshold, for example based on a rotational speed of the shaft, in order to effect the change in the operating state. Such an implementation can, like the operation of a closed control loop, improve the operation reliability of the bearing assembly, but can do so in a manner that is simpler and more economical to implement.

In a bearing assembly according to an exemplary embodiment, the magnetic field can optionally comprise a permanent magnet and/or a quasi-permanent magnet. In this way it can be possible to further improve the operation reliability of the bearing assembly because in this case, even if the electrically-powered magnetic field and/or the control apparatus fails, the viscosity of the magnetorheological fluid is determined by the permanent magnet and/or the quasi-permanent magnet. In such an embodiment, the quasi-permanent magnet is preferably a magnet which has high remanence or residual magnetization. Such a magnet can for example be realized in the case of a superconducting implementation using an appropriate superconducting magnet.

Despite the word “direction,” in the present case each individual “direction” is not necessarily a direction in the mathematical sense of a vector, but rather a line along which the corresponding movement occurs. Such a line can be straight, but can also be curved. To be distinguished here are directions which are actually directions along a line, for example the direction of movement. Thus for example a first direction can oppose a second direction, but both may extend or be oriented along a line which is also designated as a direction.

A component can, for example, have an n-fold rotational symmetry, where n is an integer greater than or equal to 2. An n-fold rotational symmetry exists if the component in question can be rotated about an axis of rotation or symmetry by (360°/n) and still look the same, i.e. upon a corresponding rotation it is substantially mapped onto itself in the mathematical sense. In contrast, with a completely rotationally symmetric embodiment of a component, with any turn of any angular extent about the axis of rotation or symmetry, the shape of the component remains the same, i.e. is substantially mapped to itself in the mathematical sense. Both n-fold rotational symmetry and full rotational symmetry are referred to herein as rotational symmetry.

As used herein, a “friction-fit” connection results from static friction, a “materially-bonded” connection results from molecular or atomic interactions and forces, and an “interference-fit” connection results from a geometric connection of the respective connecting elements. The static friction generally presupposes a normal force component between the two connection partners.

Two objects are “adjacent” here if no further object of the same type is disposed between them. Objects are “directly adjacent” if they adjoin or abut one another, i.e. they are in contact with one another. Here a “one-piece component” is understood to mean a component that is manufactured from one continuous piece of material. The term “one-piece” can therefore be synonymously used with the terms “integral” or “one-part.”

A “mechanical coupling” of two components includes both a direct and an indirect coupling. Electrical or other components are indirectly connected via a further component or directly coupled to one other such that a signal exchange is possible between the relevant components. The respective coupling can thus be partially or fully introduced and implemented for example electrically, optically, magnetically, or using radio technology. With respect to their range of values as well as their duration, the signals here can be continuous, discrete, or, for example, comprise both types in segments thereof. They can be for example analog or digital signals. Furthermore, a signal exchange can also occur via a writing or reading of data in registers or other storage locations.

An exemplary embodiment further comprises a fan including an impeller which is disposed overhung or cantilevered on a shaft, the shaft being guided by a bearing assembly according to an exemplary embodiment.

Likewise, an exemplary embodiment comprises a method for guiding a shaft, for example of a fan, at least using a bearing assembly which comprises a bearing which is formed to at least radially guide a shaft, and a seat for the bearing. The seat is formed such that an annular gap surrounding the bearing is formed between the bearing and the seat to allow the bearing to undergo movement perpendicular to an axis of the bearing. The gap contains a magnetorheological fluid, and the bearing assembly is formed such that at a nominal rotational speed the bearing assembly is operable in a supercritical operating state. The method here comprises detecting, sensing or capturing an operating state of the bearing assembly and changing a strength of a magnetic field to which the magnetorheological fluid is subjected. In this manner, when the bearing assembly approaches a critical rotational speed, the magnetorheological fluid is subjected to a magnetic field of such a strength that the operating state of the bearing assembly changes from a supercritical to a subcritical operating state, or from a subcritical to a supercritical operating state. Here “changing the strength of the magnetic field” can also mean an initial generation or turning-on of such a magnetic field, since with such a change, for example, the magnetic field is changed from a strength of zero or a strength which corresponds to the magnetic field of the Earth. The same applies to turning off or removing the magnetic field.

An exemplary embodiment further comprises a non-transient computer readable medium storing program code for causing a device to perform a method according to an exemplary embodiment when the program code runs on a programmable hardware component. Here, for example, an appropriate hardware component can be a control apparatus or a component of such a control apparatus, and the appropriate program code can for example be implemented as firmware. The detection, sensing or capturing of an operating state may comprise reading a storage location, for example a register, while the changing of the strength of the magnetic field can for example be performed by recording/writing a value in a storage location, for example a register. Of course, the respective steps can also be modified and implemented by receiving or sending another information-bearing signal, for example an electrical, optical, magnetic, or radio signal. The signals here can be continuous, discrete, or comprise a combination of the two, both with respect to their duration as well as with respect to their values. Appropriate signals thus comprise for example analog signals, but also digital signals.

In an exemplary embodiment of a method, the above-mentioned method steps can be performed in the specified order, but also optionally in a different order. Thus individual process steps can optionally occur simultaneously, however also at least temporally overlapping one another, provided nothing different from this description or the technical context results.

### BRIEF DESCRIPTION OF THE DRAWINGS

Exemplary embodiments are described and explained in more detail below with reference to the accompanying Figures.

FIG. 1 is a sectional side elevational view of a bearing assembly of a fan according to an exemplary embodiment.

FIG. 2 is an enlarged view of the bearing assembly of FIG. 1.

FIG. 3 is a flowchart of a method for guiding a shaft according to an exemplary embodiment.

FIG. 4 is a schematic diagram of a bearing assembly and an associated control apparatus.

### DETAILED DESCRIPTION

In the following description of the accompanying Figures, like reference numerals refer to like or comparable components. Furthermore, summarizing reference numerals are used for components and objects that appear multiple times in an exemplary embodiment or in an illustration, but that are described together in terms of one or more common features. Components or objects that are described with the same or summarizing reference numerals can be embodied identically, but also optionally differently, in terms of individual, multiple, or all features, their dimensions, for example, as long as the description does not explicitly or implicitly indicate otherwise.

As has already been explained, in many factories, machines, and subassemblies in machine-, factory-, and vehicle engineering, the problem arises that a shaft must be rotatably supported and guided with respect to another component. Depending on the specific implementation, it can happen that, due to imbalances of forces or to other parasitic effects, a loading of the bearing can occur perpendicular to an axis of rotation of the bearing. This problem sometimes arises in connection with overhung high-speed fans; however exemplary embodiments are by no means limited to such fans. Therefore, while much of the following description relates to overhung fans, this description is provided for illustration purposes only and is not intended to limit the present disclosure to use with such fans.

In overhung high-speed fans, there is a risk that an operating rotational speed may be near or at a resonant speed of the fan or within a range of resonant speeds, and operating a fan at or near such a speed or speed range can lead to significant vibration problems. The critical rotational speed can be increased in a conventional manner by increasing the stiffness of a shaft in order to create a sufficiently large difference between the critical speed and the desired operational speed. Such a high overall stiffness is, however, realized by large shaft cross-sections and large bearings, which can cause other problems. In addition, for substantially trouble-free operation in a conventional bearing assembly, it may be necessary for a predetermined minimum load to be applied to the bearing. If the specific bearing load is inadequate, sliding movements between rolling elements and the respective raceways can arise and cause surface damage. This can lead to premature failure of the affected bearing.

In addition, it is also possible that, despite an oversized design, an operating rotational speed is still not sufficiently different from a critical rotational speed. Thus it may not be possible to increase a stiffness as much as necessary because the limits of the bearing stiffness have been reached, for example, in view of the rotational speed limit of the bearing. Likewise, tight or narrow tolerances, for example with respect to fits and bearing clearance, can be required to meet the calculated stiffness values in practice. However, for example after an overhaul, vibration problems may arise due to the installation of a modified or replacement bearing that has a greater bearing clearance because the critical rotational speed will now be lower than calculated.

Likewise, caking on the fan impeller can change over time, so that unbalanced forces and thus the overall stiffness of the system can be influenced. The installation situation can also directly or indirectly influence the stiffness values. If the values established or set during conceptualization are not realized upon installation, vibration problems can arise. Moreover, higher operating temperatures could also occur due to the oversized design.

In addition to oversized designs, designs having a so-called supercritical rotor concept are also conventionally used. High-speed fans based on a supercritical rotor concept are realized with sliding or rolling-element bearings. In such a case, the sliding or rolling-element bearings are embodied with an additional external dampener, for example a squeeze film damper bearing, so that upon traversing the resonance range only low dynamic peaks or overshoots occur.

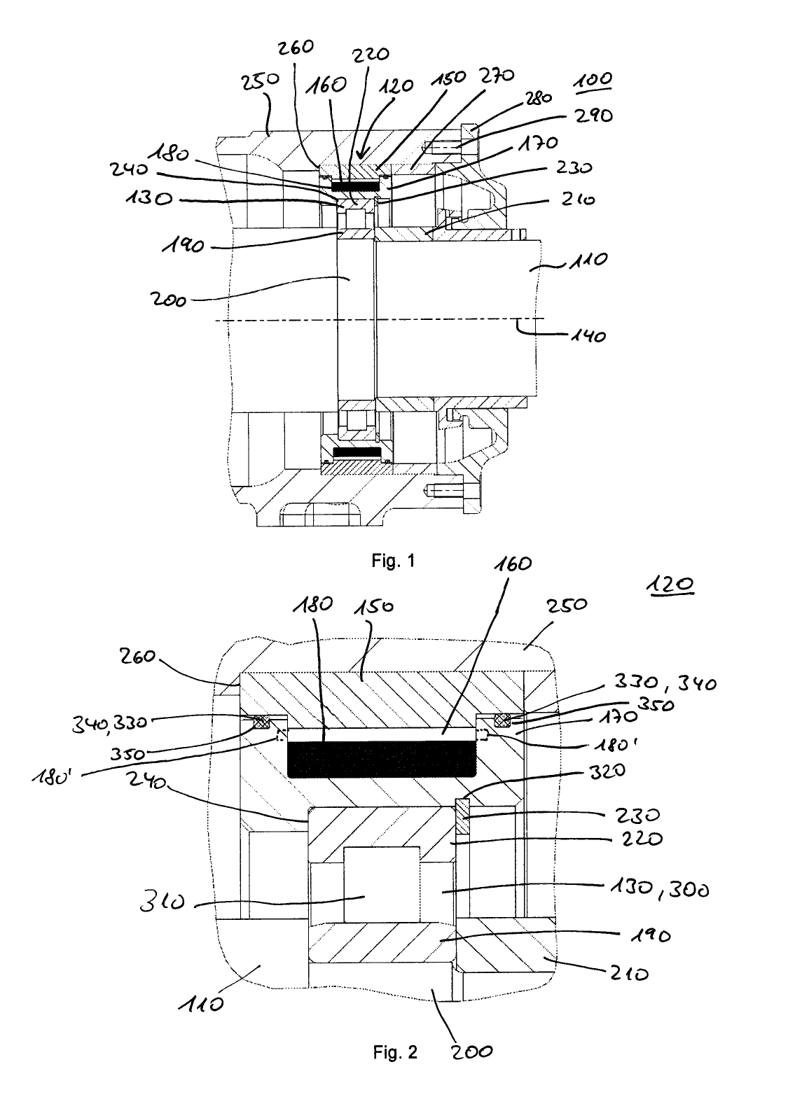

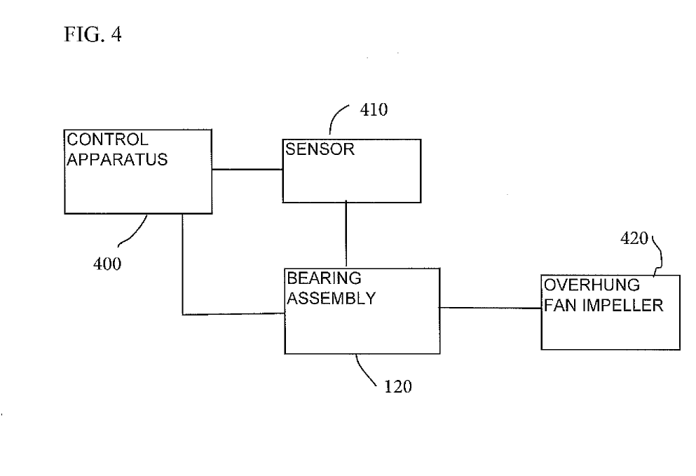

FIG. 1 shows a cross-sectional view through a fan 100 according to an exemplary embodiment. FIG. 4 schematically illustrates a bearing assembly 120 connected to an overhung fan impeller 420. The fan 100 comprises a bearing assembly 120 according to an exemplary embodiment that includes a bearing 130 that is formed to at least radially guide the shaft 110, that is, guide the shaft 110 perpendicular to an axis 140 of the bearing 130, which axis 140 coincides with the rotational axis of the shaft 110.

The bearing assembly 120 further comprises a seat 150 for the bearing 130 that is configured such that an annular gap 160 surrounding the bearing 130 is formed between the bearing 130 and the seat 150. Due to the gap 160, the bearing 130 can undergo a movement perpendicular to the axis 140 of the bearing 130. The gap 160 is filled with a magnetorheological fluid or comprises such a fluid. Fluids referred to herein as magnetorheological fluids (MRF) are fluids in which the viscosity of the fluid in question can by changed by application of a magnetic field. Magnetorheological fluids can thus for example be implemented as a suspension of magnetically-polarizable particles in an appropriate carrier fluid, if these particles for example are sufficiently finely dispersed.

In the exemplary embodiment shown in FIG. 1, the bearing assembly 120 further comprises a bushing 170 and a magnetic field source 180 that are disposed along the radial direction between the bearing 130 and the seat 150. The precise structure of the bearing assembly is, however, illustrated and explained in more detail in connection with the enlarged cross-sectional view shown in FIG. 2.

Here the bearing 130 having an inner ring 190 is mechanically connected to a shaft shoulder 200. A friction-fit connecting technique, for example a press fit, can be used here. The inner ring 190 of the bearing 130 is fixed on the shaft 110 by a sleeve or collar 210.

The bearing 130 further comprises an outer ring 220, which is axially fixed in the bushing 170 by a securing ring 230 and a projection 240. The outer ring 220 is also mechanically connected by a friction-fit connection such as a press fit to the bushing 170.

The seat 150 is in turn fixed in the axial direction in a housing 250 of the fan via a shoulder 260 on one side and a spacer 270 as well as a housing cover 280 on the other side. Here, the housing cover 280 is connected to the housing 250 via a screw connection 290.

FIG. 2 shows an enlarged view of the bearing assembly 120 from FIG. 1. Thus FIG. 2 shows that the bearing 130 is more specifically a cylindrical roller bearing 300 that comprises a plurality of cylindrical rolling elements 310. These elements 310 roll on corresponding raceways on the inner ring 190 and the outer ring 220 and thus make possible the guiding and rotatability of the inner ring 190 relative to the outer ring 220 with respect to the axis 140 of the bearing 130 in a known manner; axis 140 is not shown in FIG. 2. In this way the cylindrical roller bearing 300 substantially makes possible a guiding along the radial direction, i.e. perpendicular to the axis 140.

Of course, in other exemplary embodiments of a bearing assembly 120 and/or a fan 100, bearings other than cylindrical roller bearings can be used. Thus for example ball bearings, needle bearings, tapered roller bearings, barrel roller bearings as well as other rolling-element bearings, but also sliding bearings, can be used in the context of additional exemplary embodiments of the present teachings.

FIG. 2 also shows that the securing ring 230 is disposed in a corresponding groove 320 of the bushing 170. The outer ring 220 of the bearing 130 is thus fixed in its axial position via the securing ring 230 inserted in the groove 230, and the projection 240.

Here the outer ring 220 has flanges for guiding the cylindrical rolling elements 310, while the inner ring 190 is embodied without flanges. The cylindrical roller bearing 300 thus makes possible a compensation of an axial displacement of the shaft 110. The bearing 130 can thus for example be used as a non-locating bearing as part of a locating/non-locating bearing assembly. Of course in an embodiment there may not only be a non-locating bearing or a locating bearing of a locating/non-locating bearing assembly; bearings of a floating bearing assembly and other bearing combinations can also be used.

FIG. 2 shows in addition that the bearing assembly 120 in the present embodiment comprises two seal elements 330 which are implemented as O-rings 340. Here the seal elements 330 are inserted into corresponding grooves 350 of the bushing 170 and seal the gap 160 to prevent egress or leakage of the magnetorheological fluid located in the gap. The two seal elements 330 are thus spaced from one another along the axis 140. Because of their elasticity, the seal elements 330 additionally make possible the generation of a spring effect perpendicular to the axis 140 of the bearing 130, so that the seal elements 330 can exert a force in the radial direction on the bearing 130, which force is conveyed by the bushing 170 in the present exemplary embodiment. Thus by using an appropriate design of the sealing elements 330, the bearing assembly 120 can be precisely designed such that at a nominal rotational speed of the bearing assembly 120 it is in a supercritical operating state, i.e., is operated at a rotational speed that is above the resonance frequency with respect to vibrations/oscillations perpendicular to the axis 140 of the bearing 130.

At this point it is appropriate to point out that instead of two separate components in the form of the bushing 170 and the outer ring 220 of the bearing 130, these can also be implemented as a common component, e.g., as a specially designed outer ring 220. In such a case the outer ring 220 can comprise the corresponding receptacles (e.g., grooves) for the seal elements 330. The bushing 170 therefore represents only one example of an optional component. In other exemplary embodiments, the arrangement of the outer ring 220 and inner ring 190, and their roles with respect to the gap 160 can be reversed.

In the exemplary embodiment shown here, as has already been mentioned above in the context of FIG. 1, that the bearing assembly 120 includes the magnetorheological fluid in the region of the gap 160, and the viscosity of this fluid can be changed by the application of an appropriate magnetic field. In order to technically exploit this property, the bearing assembly 120 includes a magnetic field source 180, which can be, for example, a coil that generates an appropriate magnetic field that acts on the magnetorheological fluid in the gap 160. The strength of the magnetic field can be adjustable or controllable by using such a coil, or also by using appropriate conductor loops or other electrical conductors.

An appropriate bearing assembly 120 and/or a fan 100 can optionally further comprise a control apparatus 400, illustrated schematically in FIG. 4. In such a case the control apparatus 400 can be configured to precisely control the magnetic field source 180 such that when a critical rotational speed of the bearing assembly 120 is approached, the magnetorheological fluid is subjected to a magnetic field of such a strength that the bearing assembly 120 changes from a supercritical to a subcritical operating state or from a subcritical to a supercritical operating state. By changing the strength of the magnetic field, the operating state of the bearing assembly 120 can thus traverse the critical range even without further intervention or changing of parameters. In addition, a bearing assembly 120 according to an exemplary embodiment can optionally comprise at least one sensor, 410 in FIG. 4, which is precisely in the position to at least partially detect, sense or capture a current operating state of the bearing assembly 120. This sensor 410 can be coupled with the control apparatus 400, so that the control apparatus 400 can be precisely controlled, at least partially based on the current operating state of the magnetic field source 180 captured by the sensor 410, to change the operating state of the bearing assembly. Such a sensor 410 can for example be a rotational speed sensor or a position sensor which determines, for example, a position of the shaft 110. Likewise, acceleration sensors can be used that detect or sense forces or accelerations acting on the shaft 110.

For example, the control apparatus 400 can then control the magnetic field 180 using a closed control loop, or also using a controller, so as to adapt or regulate the viscosity of the magnetorheological fluid in the above-described manner.

The use of magnetorheological fluids as damping elements in impeller-side sliding or rolling-element bearings in fan applications or also other systems makes it possible to reach a desired operating point without a significant impairment caused by vibrations/oscillations. By the application of an appropriate magnetic field that acts on the magnetorheological fluid, the stiffness or viscosity of the magnetorheological fluid can be significantly varied. In this way the overall stiffness of the system or the bearing assembly 120 can be influenced in a targeted manner.

In the exemplary embodiments described here, on the one hand the vibration amplitude of the system is damped by an active external damping of the impeller-side bearing 130. On the other hand, the overall stiffness of the system is also changed within the shortest possible time by changing the magnetic field. Thus the critical frequency range can be shifted in a similarly short time. Thus if a rotational speed is reached, for example by accelerating the shaft, which is near a critical rotational speed of the system or of the assembly, the viscosity of the magnetorheological fluid in the gap 160 can be reduced in a very short time, for example in less than 10 ms, often even faster, by appropriately controlling the magnetic field source 180, so that with a substantially unchanged rotational speed of the shaft 110, the natural frequency of the entire system is shifted to below the rotational speed of the shaft 110.

In other words, when starting the system the magnetic field 180 can be controlled by the control apparatus 400 such that the magnetorheological fluid is in a relatively highly viscous state. In this way a correspondingly-high stiffness with a correspondingly high critical frequency or resonance frequency is conferred to the system. If this critical frequency or a corresponding range around this critical frequency is reached, the control apparatus 400 can control the magnetic field source such that the natural frequency drops to well below the current rotational speed.

The regulation or control algorithm can thus ensure a high overall stiffness of the system during system startup. A possible critical resonance range is thus usually shifted away from the actual rotational speeds that typically occur. This system is in a state of high stiffness, i.e. in a “hard” state.

When approaching this resonance range, the system is then almost instantaneously switched to “soft” by the regulating algorithm of the control apparatus 400, and the critical frequency range thus falls at rotational speeds far below the actual rotational speed. The rapid variation of the viscosity or stiffness of the magnetorheological fluid thus makes it possible to reach a supercritical operating point without an “actual” traversing of a resonance spectrum occurring. The magnetic field required for influencing the stiffness or viscosity can be controlled via a control loop, which may comprise appropriate sensors or an appropriate sensor technology, a control apparatus 400, and an appropriate magnetic field source 180. A readjustment after a change to the system has taken placed, such as, e.g., by increased or decreased caking on the impeller 420 or replacement of a bearing, can also be made possible in this way. Despite these induced small changes of the bearing spring stiffness, a trouble-free operation can thereby often be ensured. Of course, a simplified design in the context of an exemplary embodiment can also be implemented, wherein a corresponding controlling of the magnetorheological fluid in the gap 160 is performed using a control loop in accordance with, for example, the rotational speed of the system.

In addition, the magnetic field source 180 can also comprise one or more permanent magnets and/or quasi-permanent magnets. In this way it can be possible to obtain emergency running properties (dry-running operation) even in the event of any sudden power failure, wherein the magnetic field generated, for example by coils, is supplemented by permanent magnets.

Likewise, a semiactive system can be implemented in which the viscosity of the magnetorheological fluid is determined by a quasi-permanent magnet having high remanence. In this way it is possible for a permanent power supply to be avoided over a long period for such a bearing assembly 120. A quasi-permanent magnet can be implemented based on superconducting systems, for example.

Although the exemplary embodiment shown in FIG. 1 and FIG. 2 is based on a cylindrical roller bearing 300 as the bearing 130, it can be implemented using other bearings, as was already briefly explained above. Together with the bushing 170 or the outer ring 220, the seat 150 forms a ring-shaped component which contains the magnetorheological fluid. The gap 160 serves to damp the movements perpendicular to the axis 140 and is therefore also referred to as a damping gap.

In addition to the magnetic field source 180, a bearing assembly 120 can additionally or alternatively comprise one or more further magnetic field sources 180′, which for example may be disposed along the axial direction, i.e., along the axis 140 at the same height as the gap 160, and are shown in FIG. 2 as dotted structures. Here the magnetic field sources 180 can thus be disposed flush left/left-aligned and flush right/right aligned to the gap 160, and for example can comprise the previously mentioned permanent magnets or quasi-permanent magnets, or also other magnetic field sources, e.g. coils, conductors, or conductor loops.

By utilizing a bearing assembly 120 according to an exemplary embodiment, a damping bearing can thus be implemented, using which the resonance range can be actively set. The change in the stiffness or viscosity of the magnetorheological fluid in the gap 160 typically occurs very quickly, so that the vibration amplitude is scarcely or only very briefly increased when passing through the resonance range. In this way a better-adapted design of the fan or its bearing assembly can be made possible, since a high stiffness need not be implemented by other structural means. In this way, for example, an increase in the bearing service life can be achievable, since early failures due to insufficient (under) load problems are not expected. Likewise, it is possible to achieve lower friction and lower bearing temperatures.

In addition, when an overhaul is performed, tight/narrow tolerances with respect to the bearing 130 need not necessarily be used, nor are other special designs required, since certain parameter fluctuations can be compensated due to the controllability of the viscosity Likewise it is optionally possible to drive a fan 100 according to an exemplary embodiment that is not particularly well balanced Likewise, a requirement with respect to the installation location of the fan or the bearing assembly 120 can be omitted or relaxed.

By utilizing such a bearing assembly 120, higher rotational speed ranges can also be realized, without the risk hat resonance effects in significant amounts will occur. Likewise a permanent external oil supply as well as the use of hydraulic power units can optionally be avoided. An operational optimization can also optionally occur because the stiffness of the magnetorheological fluid and/or any vibrations that occur can be compensated in accordance with the rotational speed by controlling the viscosity of the magnetorheological fluid.

A simplified construction can also thereby make possible an easier transfer to other applications wherein vibration damping is advisable or necessary. Thus exemplary embodiments of a bearing assembly 120 are by no means limited to the above-described fans 100, even if the focus in the present description has been on the damping of a bearing assembly 120, including magnetorheological fluids, of an overhung fan 100.

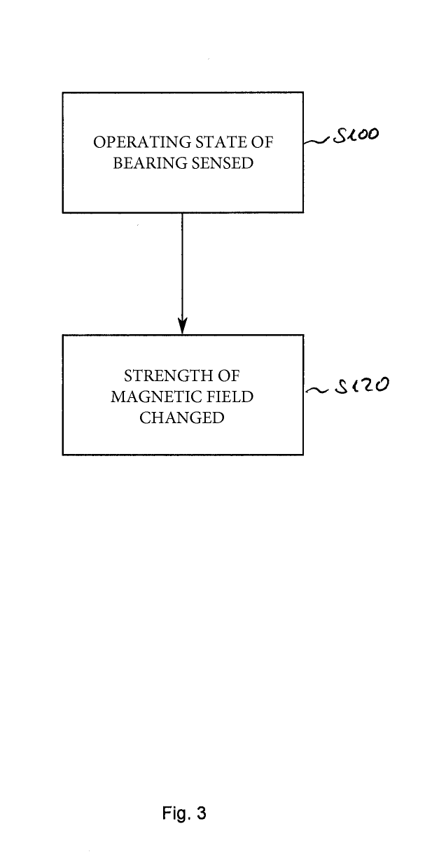

Finally, FIG. 3 shows a flow chart of a method according to an exemplary embodiment for guiding a shaft 100 using a bearing assembly 120 as described above. First, in a step S100 the operating state of the bearing assembly 120 is sensed or detected. Subsequently, in the context of a step S120 the strength of the magnetic field to which a magnetorheological fluid is subjected is changed so that when the critical rotational speed of the bearing assembly 120 is approached, the magnetorheological fluid is subjected to a magnetic field of such a strength that by changing the strength of the magnetic field, the bearing assembly 120 changes from a supercritical to a subcritical operating state, or from a subcritical to a supercritical operating state.

An exemplary embodiment can thus make possible a damping of an overhung fan 100 using a magnetorheological fluid. The reliability of a system, machine, or subassembly comprising a bearing assembly 120 can thereby optionally be increased.

In an exemplary embodiment of a method, the above-mentioned method steps can be performed in their given order, but optionally also in a different order. Thus individual process steps can optionally occur simultaneously, however also at least temporally overlapping one another, provided nothing significantly different from this description or the technical context results.

Although some aspects of the present invention have been described in the context of a device, it is to be understood that these aspects also represent a description of a corresponding method, so that a block or a component of a device is also understood as a corresponding method step or as a feature of a method step. In an analogous manner, aspects which have been described in the context of or as a method step also represent a description of a corresponding block or detail or feature of a corresponding device.

Depending on certain implementation requirements, exemplary embodiments of the invention may be implemented in hardware and/or in software. The implementation can be performed using a digital storage medium, for example a floppy disk, a DVD, a Blu-Ray disc, a CD, a ROM, a PROM, an EPROM, an EEPROM or a flash memory, a hard drive or another magnetic or optical storage device, on which electronically readable control signals are stored, which interact or can interact with a programmable hardware component such that the respective method is performed.

A programmable hardware component can be formed by a processor, a computer processor (CPU=central processing unit), a graphics processor (GPU=graphics processing unit), a computer, a computer system, an application-specific integrated circuit (ASIC), an integrated circuit (IC), a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present invention are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A further exemplary embodiment is a data stream, a signal sequence, or a sequence of signals which represents the program for performing one of the methods described herein. The data stream, the signal sequence, or the sequence of signals can for example be configured to be transferred via a data communications connection, for example via the Internet or another network. Exemplary embodiments are thus also signal sequences which represent data, which are intended for transmission via a network or a data communications connection, wherein the data represent the program.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components, and thus for example also perform complex processes using actuators.

The above-described exemplary embodiments represent only an illustration of the principles of the present invention. It is understood that modifications and variations of the arrangements and details described herein will be clear to other persons of skill in the art. It is therefore intended that the invention be limited only by the scope of the following patent claims, and not by the specific details which have been presented with reference to the description and the explanation of the exemplary embodiments.

The features disclosed in the foregoing description, the following claims, and the accompanying Figures can be meaningful and can be implemented both individually as well as in any combination for the realization of an exemplary embodiment in its various embodiments.

### REFERENCE NUMBER LIST

100 Fan
110 Shaft
120 Bearing assembly
130 Bearing
140 Axis
150 Seat
160 Gap
170 Bushing
180 Magnetic field source
190 Inner ring
200 Shaft shoulder
210 Sleeve
220 Outer ring
230 Securing ring
240 Projection
250 Housing
260 Shoulder
270 Spacer
280 Housing cover
290 Screw connection
300 Cylindrical roller bearings
310 Cylindrical rollers
320 Groove
330 Seal element
340 O-ring
350 Groove
400 Control apparatus
410 Sensor
420 Overhung fan impeller
S100 Detecting/sensing an operating state
S120 Changing the strength of the magnetic field

What is claimed is:

1. A bearing assembly comprising:
a bearing configured to at least radially guide a shaft;
a seat for the bearing;
an annular gap surrounding the bearing, the annular gap allowing the bearing to move in a direction perpendicular to an axis of the bearing;
a magnetorheological fluid in the gap;
a magnetic field source configured to generate a magnetic field in the magnetorheological fluid; and
a control apparatus configured to control the magnetic field source to change a strength of the magnetic field in response to a critical rotational speed of the bearing assembly being approached in order to change a viscosity of the magnetorheological fluid and change an operating state of the bearing assembly from a supercritical operating state to a subcritical operating state or from a subcritical operating state to a supercritical operating state.

2. The bearing assembly according to claim 1, further comprising at least one seal element configured to seal the gap and to exert a spring force on the bearing perpendicular to the axis of the bearing.

3. The bearing assembly according to claim 1, further comprising at least one sensor for at least partially detecting an operating state of the bearing assembly, the sensor being in communication with the control apparatus, and wherein the control apparatus is configured to control the magnetic field source at least partially based on the detected operating state.

4. The bearing assembly according to claim 1, wherein the control apparatus is configured to control the magnetic field source based on a closed control loop in order to effect the change of the operating state.

5. The bearing assembly according to claim 1, wherein the magnetic field source comprises a permanent magnet or a quasi-permanent magnet or both a permanent magnet and a quasi-permanent magnet.

6. The bearing assembly according to claim 1, wherein the control apparatus is configured to control the magnetic field source based on a sensed condition of the bearing.

7. The bearing assembly according to claim 1, further comprising:
at least one seal element configured to seal the gap and to exert a spring force on the bearing perpendicular to the axis of the bearing; and
at least one sensor for at least partially detecting an operating state of the bearing assembly, the sensor being in communication with the control apparatus,
wherein the control apparatus is configured to control the magnetic field source at least partially based on the detected operating state, and

8. The bearing assembly according to claim 7, wherein the magnetic field source comprises a permanent magnet or a quasi-permanent magnet or both a permanent magnet and a quasi-permanent magnet and wherein the control apparatus is configured to control the magnetic field source based on a sensed condition of the bearing.

9. An overhung fan including a bearing assembly according to claim 1.

10. A method for changing an operating state of a bearing assembly including a rotatable shaft comprising:
providing a bearing seat that includes a gap between the bearing and the bearing seat;
providing a magnetorheological fluid in the gap;
providing a magnetic field source positioned to generate a magnetic field in the magnetorheological fluid;
detecting the operating state of the bearing assembly; and
changing a strength of the magnetic field in response to an operating rotation speed of the bearing assembly approaching within a predetermined distance of a critical rotational speed of the bearing assembly to change the operating state of the bearing from a supercritical operating state to a subcritical operating state, or from the subcritical operating state to the supercritical operating state.

11. A non-transient computer readable medium containing instructions that when executed by a computer processor cause that computer processer to detect an operating state of a bearing having a magnetorheological fluid in a gap and control a strength of a magnetic field applied to the magnetorheological fluid based on the detected operating state of the bearing.
